(19) United States
(12) Patent Application Publication
(10) Pub. No.: US 2020/0408319 A1
(43) Pub. Date: Dec. 31, 2020

(54) ELECTROMAGNETIC VALVE

(71) Applicant: NIDEC TOSOK CORPORATION, Kanagawa (JP)

(72) Inventors: Dongming CHEN, Kanagawa (JP); Tomohiko NAKANISHI, Kanagawa (JP)

(73) Assignee: NIDEC TOSOK CORPORATION, Kanagawa (JP)

(21) Appl. No.: 15/930,416

(22) Filed: May 12, 2020

(30) Foreign Application Priority Data
Jun. 28, 2019 (JP) 2019-120688

(51) Int. Cl. F16K 31/06; F16K 11/07; F16K 27/04

(52) U.S. Cl. CPC F16K 31/0613; F16K 27/048; F16K 11/0704

(57) ABSTRACT

An electromagnetic valve includes a solenoid having a plunger supported movably along an axial direction, and a valve mechanism having a valve body in a columnar shape supported movably along the axial direction together with the plunger and switching between passage and blockage of a fluid. The solenoid has a core and a yoke which guide the plunger. The plunger has a plunger pin protruding at least on the other side in the axial direction in the one side in the axial direction and the other side in the axial direction. A rust-resistant member having rust resistance is provided on an end of the yoke on the other side in the axial direction, wherein the plunger pin contacts and separates from the rust-resistant member as the plunger moves, and the rust-resistant member has an area larger than a contact area of the plunger pin with the rust-resistant member.

### CROSS-REFERENCE TO RELATED APPLICATIONS

The present invention claims priority under 35 U.S.C. § 119 to Japanese Application No. 2019-120688 filed on Jun. 28, 2019 the entire content of which is incorporated herein by reference.

### BACKGROUND

### Field of the Invention

The disclosure relates to an electromagnetic valve.

### Background

For example, an electromagnetic hydraulic control valve mounted on a hydraulic control device of an automatic transmission is known. The conventional electromagnetic hydraulic control valve includes a spool valve and a linear solenoid that drives the spool valve. The spool valve includes a sleeve having a circular cylindrical shape and a plurality of oil ports, and a spool slidably disposed in the sleeve and switching a communication state of each oil port according to a position in the sleeve. The linear solenoid includes a coil that generates a magnetic force when energized, a yoke having magnetism that covers the outer peripheral side of the coil, and a plunger that is moved by the magnetic force to slide the spool within the sleeve. Further, in the above electromagnetic hydraulic control valve, the plunger is able to take a state of contacting an end of the yoke and a state of being separated from the end of the yoke as the plunger moves.

However, in the conventional electromagnetic hydraulic control valve, since the yoke is made of a ferromagnetic material such as iron, rust may occur at the end of the yoke with which the plunger is in contact. Therefore, it is conceivable to apply plating to prevent rust on this portion. However, since the plunger collides, the plating peels off, which results in rust.

### SUMMARY

An exemplary embodiment of an electromagnetic valve of the disclosure includes a solenoid having a bobbin in a cylindrical shape having a through hole which penetrates along an axial direction, a plunger inserted into the through hole and supported movably along the axial direction, and a coil wound around an outer periphery of the bobbin and generating a magnetic force when energized to move the plunger; and a valve mechanism having a flow path member connected to the solenoid and having a first flow path, a second flow path, a relay flow path connecting the first flow path and the second flow path, and a valve body housing disposed adjacent to the relay flow path along the axial direction, and a valve body in a columnar shape inserted into the valve body housing, supported movably along the axial direction together with the plunger, and switching between passage and blockage of a fluid between the first flow path and the second flow path via the relay flow path; wherein the solenoid has a core in a cylindrical shape provided on one side of the through hole in the axial direction, guiding the plunger when the plunger moves, and having magnetism, and a yoke in a cylindrical shape provided on the other side of the through hole in the axial direction, guiding the plunger when the plunger moves, and having magnetism; the plunger has a plunger pin protruding at least on the other side in the axial direction in the one side in the axial direction and the other side in the axial direction; and a rust-resistant member having rust resistance is provided on an end of the yoke on the other side in the axial direction, wherein the plunger pin comes into contact with and separates from the rust-resistant member as the plunger moves, and the rust-resistant member has an area larger than a contact area of the plunger pin with the rust-resistant member.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a longitudinal sectional view showing a first exemplary embodiment of an electromagnetic valve of the disclosure.

FIG. 2 is an enlarged view of the region [A] circled by a one-dot chain line in FIG. 1.

FIG. 3 is a view showing a state in which a plunger has moved from the state shown in

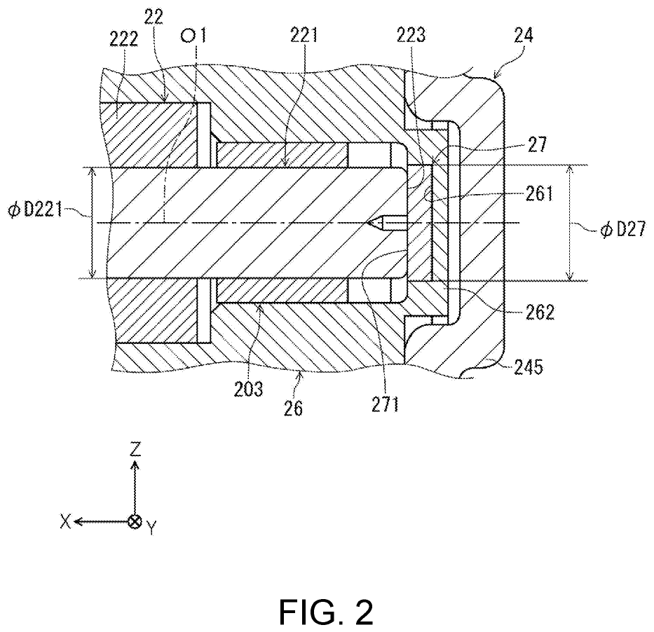

FIG. 2

FIG. 4 is a longitudinal sectional view showing a second exemplary embodiment of an electromagnetic valve of the disclosure.

### DETAILED DESCRIPTION

Hereinafter, an electromagnetic valve of the disclosure will be described in detail based on exemplary embodiments of the disclosure shown in the accompanying drawings.

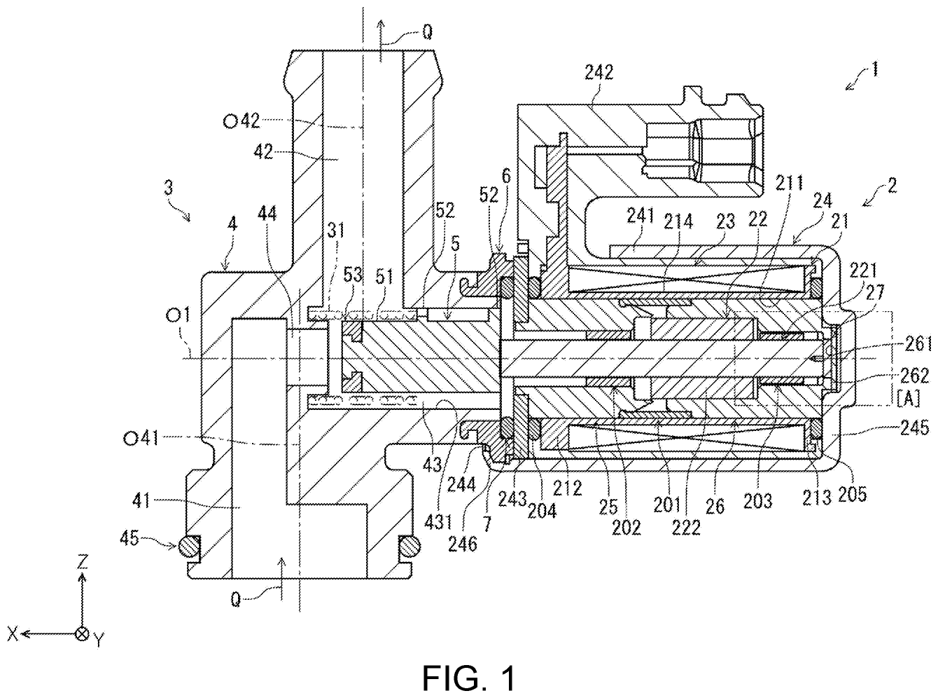

A first exemplary embodiment of an electromagnetic valve of the disclosure will be described with reference to FIGS. 1 to 3. Further, hereinafter, for convenience of description, three axes orthogonal to each other are set as an X axis, a Y axis, and a Z axis. For example, an XY plane including the X axis and the Y axis is horizontal, and the Z axis is vertical. A direction parallel to the X axis is referred to as “the axial direction (the axis O1 direction),” and a radial direction with this axis as the center is simply referred to as “the radial direction,” and a peripheral direction with the axis as the center is simply referred to as “the peripheral direction.” Further, the positive side in the X axis direction may be referred to as “the one side in the axial direction” or simply as “the one side,” and the negative side in the X axis direction may be referred to as “the other side in the axial direction” or simply as “the other side.” In the specification, the vertical direction, the horizontal direction, the upper side and the lower side are simply names for describing the relative positional relationship of each part, and the actual dispositional relationship and the like may be a dispositional relationship and the like other than the dispositional relationship and the like indicated by these names.

An electromagnetic valve 1 shown in FIG. 1 is used, for example, mounted on an internal combustion engine such as a gasoline engine. Examples of exhaust gas discharged from the internal combustion engine include exhaust gas generated by combustion of fuel in the internal combustion engine, blow-by gas leaking from a piston sealer of the internal combustion engine, fuel vapor gas generated by evaporating fuel in a fuel tank, and the like. Further, in this exemplary embodiment, the electromagnetic valve 1 is used as a switching valve that switches between passage and blockage of blow-by gas.

As shown in FIG. 1, the electromagnetic valve 1 includes a solenoid 2 disposed on the negative side in the X axis direction and a valve mechanism 3 disposed on the positive side in the X axis direction. Hereinafter, a configuration of each part will be described.

The solenoid 2 has a bobbin 21, a plunger 22, a coil 23, a case 24, a core 25, and a yoke 26.

The bobbin 21 is a member in a cylindrical or substantially cylindrical shape having a through hole 211. The through hole 211 penetrates along the axis O1 direction parallel to the X axis direction. Further, the inner diameter of the through hole 211 is constant along the axis O1 direction. The bobbin 21 has a flange 212 that protrudes in the radial direction on the one end side, and a flange 213 that protrudes in the radial direction on the other end side. The bobbin 21 is made of, for example, various thermosetting resins such as a polyester resin and a polyimide resin.

A coil 23 having conductivity is wound around an outer periphery 214 of the bobbin 21. When the coil 23 is energized, a magnetic circuit is provided by the bobbin 21, the core 25, and the yoke 26, and a magnetic force may be generated. In this way, the plunger 22 may be moved back and forth along the axis O1 direction.

The core 25 and the yoke 26 are inserted into the through hole 211 of the bobbin 21, and the plunger 22 is inserted further to the inner side.

The core 25 is disposed on the one end side in the axis O1 direction, and the yoke 26 is disposed on the other end side in the axis O1 direction.

The core 25 has a circular cylindrical or substantially circular cylindrical shape as a whole, and is disposed parallel to the X axis direction. Further, the yoke 26 is closed on the other end side by a wall 262, also has a circular cylindrical or substantially circular cylindrical shape as a whole, and is disposed parallel to the X axis direction. The core 25 and the yoke 26 are made of a magnetic material, that is, made of a metal material having magnetism. For the metal material thereof, for example, iron is preferably used. In this way, it is possible to generate a magnetic circuit that may sufficiently move the plunger 22 back and forth.

Further, the solenoid 2 has a connecting member 201 for connecting the core 25 and the yoke 26 in the through hole 211 while keeping the core 25 and the yoke 26 apart. The connecting member 201 has a circular cylindrical or substantially circular cylindrical shape, and the other end of the core 25 and the one end of the yoke 26 are fitted inside the connecting member 201. The connecting member 201 is made of a nonmagnetic and rust-resistant metal material such as austenitic stainless steel.

The plunger 22 is disposed to cross the core 25 and the yoke 26 and is supported to be movable alternately between the one end side and the base end side along the axis O1 direction, that is, to be movable back and forth. The plunger 22 has a plunger body 222 in a circular cylindrical or substantially circular cylindrical shape and a plunger pin 221 inserted into the plunger body 222.

The plunger body 222 is guided by the core 25 and the yoke 26 when the plunger 22 moves.

In the exemplary embodiment, the plunger pin 221 protrudes on both of the one side and the other side in the axis O1 direction, but it is not limited thereto; the plunger pin 221 may protrude only on the other side in the axis O1 direction.

Further, in the plunger 22, the plunger pin 221 is supported by a bush 202 in the core 25, and the plunger pin 221 is supported by a bush 203 in the yoke 26. In this way, the plunger 22 may move back and forth smoothly.

The case 24 houses the bobbin 21, the plunger 22, the coil 23, the core 25, and the yoke 26. The case 24 has a case body 241, a connector member 242, and a ring member 243.

The case body 241 has a circular cylindrical or substantially circular cylindrical shape with a bottom. That is, the case body 241 is a member in a cylindrical or substantially cylindrical shape having an opening 244 that opens on the one side in the axis O1 direction and a wall 245 that closes the other side. The yoke 26 contacts the wall 245 from the one end side.

The ring member 243 has a circular ring or substantially circular ring shape and is disposed concentrically with the core 25 on the outer side of the core 25 in the radial direction. The ring member 243 contacts the core 25 from the one end side.

Like the core 25, the case body 241 and the ring member 243 are made of a magnetic metal material such as iron.

The connector member 242 is connected to a connector (not shown) that energizes the coil 23. The connector member 242 is made of, for example, a thermosetting resin, like the bobbin 21.

Further, the solenoid 2 includes in the case 24 a gasket 204 disposed between the ring member 243 and the flange 212 of the bobbin 21, and a gasket 205 disposed between the wall 245 of the case body 241 and the flange 213 of the bobbin 21.

The gasket 204 has a ring or substantially ring shape and is disposed concentrically with the core 25 on the outer peripheral side of the core 25. The gasket 204 is in a compressed state between the ring member 243 and the flange 212 of the bobbin 21, whereby the space between the ring member 243 and the flange 212 may be sealed.

The gasket 205 has a ring or substantially ring shape and is disposed concentrically with the yoke 26 on the outer side of the yoke 26 in the radial direction. The gasket 205 is in a compressed state between the wall 245 of the case body 241 and the flange 213 of the bobbin 21, whereby the space between the wall 245 and the flange 213 may be sealed.

In addition, the gaskets 204 and 205 are made of an elastic material having elasticity. The elastic material is not particularly limited, and examples thereof include various rubber materials such as urethane rubber and silicone rubber.

The valve mechanism 3 has a flow path member 4, a valve body 5, a connecting member 6, and a gasket 7.

The flow path member 4 is a member connected to the solenoid 2 via the connecting member 6, and is configured to allow a fluid Q to pass therethrough. As described above, in this exemplary embodiment, the electromagnetic valve 1 is used as a switching valve that switches between passage and blockage of the blow-by gas. Therefore, the fluid Q serves as the blow-by gas.

The flow path member 4 has a first flow path 41, a second flow path 42, a relay flow path 44, and a valve body housing 43 inside.

The first flow path 41 is provided along the Z axis direction and opens toward the negative side in the Z axis direction. Further, the first flow path 41 side is connected to, for example, a fixing structure (not shown) to which the electromagnetic valve 1 is fixed, and is in a state of being opened to the atmosphere. Further, a gasket 45 for sealing between the flow path member 4 and the fixing structure is fitted from the outer side.

The second flow path 42 is also provided along the Z axis direction and opens toward the positive side in the Z axis direction. In addition, a central axis O42 of the second flow path 42 is located on the negative side in the X axis direction with respect to a central axis O41 of the first flow path 41. Further, the second flow path 42 is connected to, for example, a flexible tube.

The relay flow path 44 is provided along the X axis direction, that is, along the axis O1 direction and connects the first flow path 41 and the second flow path 42. For example, in the case where the internal combustion engine equipped with the electromagnetic valve 1 is a naturally aspirated engine, as shown in FIG. 1, the fluid Q flows from the first flow path 41 to the second flow path 42 via the relay flow path 44. Further, in the case where the internal combustion engine equipped with the electromagnetic valve 1 is a turbo engine, when the boost pressure acts, the fluid Q flows from the second flow path 42 to the first flow path 41 via the relay flow path 44.

The valve body housing 43 for movably housing the valve body 5 is disposed adjacent to the relay flow path 44 on the negative side in the X axis direction. The valve body housing 43 is provided along the X axis direction (the axis O1 direction) and opens toward the negative side in the X axis direction. A cross-sectional shape of the valve body housing 43 in a direction of the valve body housing 43 orthogonal to the X axis direction, i.e. a transverse sectional shape thereof, is circular or substantially circular, and an inner diameter of the valve body housing 43 is constant along the X axis direction. In addition, the inner diameter of the valve body housing 43 is larger than the inner diameter of the relay flow path 44.

Further, the flow path member 4 is made of, for example, a thermosetting resin, like the bobbin 21.

Further, the valve mechanism 3 has a coil spring 31 housed in the valve body housing 43 together with the valve body 5. The coil spring 31 is provided on the positive side in the X axis direction with respect to the valve body 5, that is, on the one side in the axis O1 direction. In addition, the coil spring 31 is in a compressed state between the wall surface of the valve body housing 43 on the positive side in the X axis direction and the valve body 5. In this way, a pushing force for pushing the valve body 5 toward the negative side in the X axis direction, that is, the other side in the axis O1 direction may be applied. By this pushing force, the valve body 5 may be separated from the relay flow path 44, whereby the relay flow path 44 may be opened. Further, in order to close the relay flow path 44, when the plunger 22 moves toward the positive side in the X axis direction against the pushing force of the coil spring 31, the valve body 5 approaches the relay flow path 44, which may close the relay flow path 44.

The connecting member 6 has a ring or substantially ring shape and is fixed on the outer side of the valve body housing 43 in the radial direction with respect to the flow path member 4. A bent part 246 provided by bending the opening 244 side of the case 24 toward the inner side in the radial direction is hooked on the connecting member 6, that is, caulked on the opening 244 side of the case 24. The connecting member 6 is connected to the case 24 by caulking, whereby the positional relationship between the valve mechanism 3 and the solenoid 2 is restricted. In this way, the power from the solenoid 2, that is, the force of the plunger 22 may be transmitted to the valve body 5 of the valve mechanism 3, whereby the valve body 5 may be moved. The connecting member 6 is made of, for example, a nonmagnetic and rust-resistant metal material, like the connecting member 201.

The gasket 7 is disposed between the connecting member 6 and the ring member 243. The gasket 7 has a ring or substantially ring shape and is provided concentrically with respect to the valve body housing 43. The gasket 7 is in a compressed state between the connecting member 6 and the ring member 243, whereby the space between the connecting member 6 and the ring member 243 can be sealed. In addition, the gasket 7 is made of an elastic material having elasticity, like the gasket 204.

The valve body 5 in a columnar or substantially columnar shape is inserted into the valve body housing 43 of the flow path member 4. The valve body 5 is supported movably along the axis O1 direction together with the plunger 22. Then, by moving the valve body 5, the relay flow path 44 may be opened and closed as described above. In this way, the passage and blockage of the fluid Q between the first flow path 41 and the second flow path 42 may be switched via the relay flow path 44 and the valve body housing 43. In addition, the valve body 5 may be made of various metal materials, such as aluminum.

As shown in FIG. 1, the valve body 5 has a plurality of protrusions 52. Each protrusion 52 is provided to protrude from an outer periphery 51 of the valve body 5 toward its outer side in the radial direction. Further, when the valve body 5 moves, each protrusion 52 is guided in contact with an inner wall surface 431 of the valve body housing 43. In this way, the sliding area (contact area) of the valve body 5 with the inner wall surface 431 may be suppressed as much as possible, and accordingly, the sliding resistance may be suppressed as much as possible. As a result, the valve body 5 may slide stably; that is, the sliding property of the valve body 5 is improved.

Further, a gasket 53 in a ring or substantially ring shape is mounted on the valve body 5 on the positive side in the X axis direction. When the valve body 5 closes the relay flow path 44, the gasket 53 may be in close contact along the shape of the edge of the relay flow path 44. In this way, the relay flow path 44 is sufficiently closed, and thus the fluid Q is more reliably blocked. In addition, the gasket 53 is made of an elastic material having elasticity, like the gasket 204.

As described above, the yoke 26 is preferably made of iron. For the yoke 26 made of iron, since it is afraid that rust may be generated depending on the use environment of the electromagnetic valve 1, various kinds of plating such as chrome plating and the like are applied. In this way, generation of rust may be prevented.

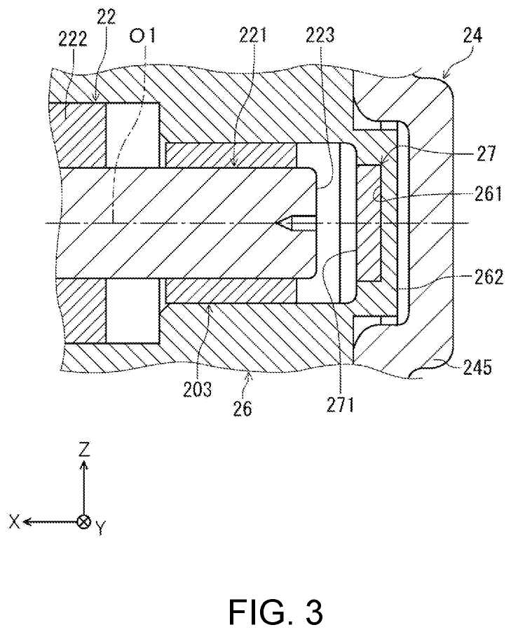

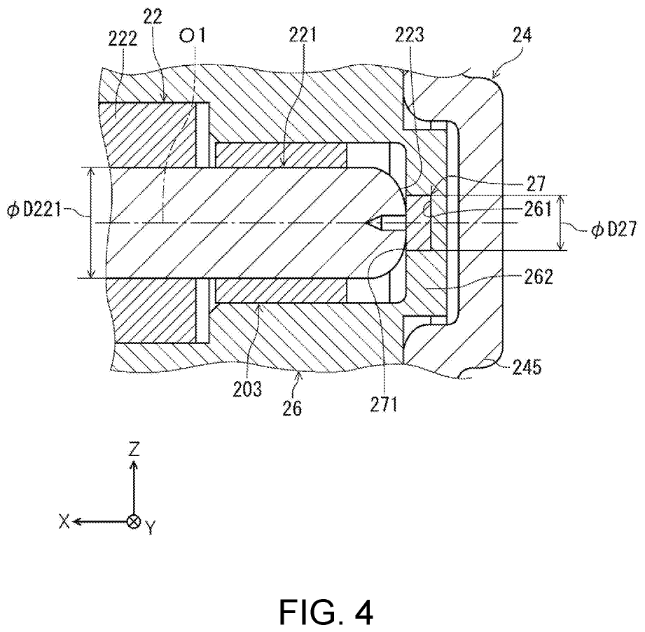

Further, as shown in FIGS. 2 and 3, a rust-resistant member 27 having rust resistance is provided on the end of the yoke 26 on the negative side in the X axis direction (the other side in the axis O1 direction), that is, provided on the wall 262.

Here, consider the case where the rust-resistant member 27 is omitted. In this case, each time the plunger 22 moves back and forth, an end surface 223 of the plunger pin 221 on the negative side in the X axis direction (the other side in the axis O1 direction) directly contacts, that is, collides with the wall 262. Then, the plating applied to the yoke 26 becomes brittle each time the plunger pin 221 collides and may eventually peel off. Rust is likely to occur in a portion where the plating has peeled off. Further, the plating peeled from the yoke 26 may, for example, enter between the yoke 26 and the plunger 22 and hinder the movement of the plunger 22.

On the other hand, in the exemplary embodiment, the rust-resistant member 27 is provided on the yoke 26. As the plunger 22 moves back and forth (moves), the end surface 223 of the plunger pin 221 comes into contact with (see FIG. 2) or separates from (see FIG. 3) the rust-resistant member 27. Further, the rust-resistant member 27 has an area larger than a contact area of the plunger pin 221 with the rust-resistant member 27. Specifically, the area of the rust-resistant member 27 on the positive side in the X axis direction, that is, the area of a facing surface 271 facing the end surface 223 of the plunger pin 221 is larger than the area of the end surface 223 of the plunger pin 221. Further, each area is set to a size that may sufficiently withstand a known collision test.

The rust-resistant member 27 as described above prevents direct collision between the plunger pin 221 and the yoke 26. In this way, the plating on the yoke 26, particularly on the wall 262, may be preserved, thereby preventing rust generated on the yoke 26. Further, since the peeling of the plating may be prevented, it is possible to prevent the movement of the plunger 22 from being hindered which may occur when the plating has peeled off, as described above.

Further, as shown in FIGS. 2 and 3, the yoke 26 has a recess 261 in the end on the negative side in the X axis direction (the other side in the axis O1 direction), that is, in the wall 262. The rust-resistant member 27 may be housed in the recess 261 by press-fitting. In this way, the rust-resistant member 27 is positioned, and the collision from the plunger pin 221 may be more reliably received. Further, the rust-resistant member 27 may be prevented from dropping out of the recess 261.

The rust-resistant member 27 is provided by a member in a plate or substantially plate shape, whose shape when viewed from the X axis direction (the axis O1 direction) is circular or substantially circular. Accordingly, when the rust-resistant member 27 is to be housed in the recess 261, the rust-resistant member 27 may be quickly and easily housed in the recess 261 regardless of the direction around the X axis. Further, although the thickness of the rust-resistant member 27 is constant, it may also be changed.

Further, the rust-resistant member 27 has a diameter φD27 larger than a diameter φD221 of the plunger pin 221. In this way, the area of the facing surface 271 of the rust-resistant member 27 may be reliably set to be larger than the area of the end surface 223 of the plunger pin 221. Further, even in the case where the contact area between the rust-resistant member 27 and the plunger pin 221 has changed as the electromagnetic valve 1 has been used for a long period of time, the rust-resistant member 27 may sufficiently contact the plunger pin 221.

As described above, the end surface 223 of the plunger pin 221 makes surface contact with the rust-resistant member 27 (see FIG. 2). In this way, the movement limit of the plunger 22 on the negative side in the X axis direction may be restricted. In addition, by the restriction of the movement limit, the movement of the plunger 22 is performed without excess or deficiency, whereby the passage and the blockage of the fluid Q may be switched more reliably.

The rust-resistant member 27 is preferably made of, for example, stainless steel. In this way, the rust-resistant member 27 itself may sufficiently maintain the rust resistance for a long period of time. Further, the rust-resistant member 27 may be made of a resin material depending on a use state and a use environment of the electromagnetic valve 1.

Hereinafter, a second exemplary embodiment of the electromagnetic valve of the disclosure will be described with reference to FIG. 4, but the description will focus on differences from the above-described exemplary embodiment, and the description of the same matters will be omitted.

This exemplary embodiment is the same as the first exemplary embodiment except that the size of the rust-resistant member is different.

As shown in FIG. 4, in the exemplary embodiment, the end surface 223 of the plunger pin 221 is rounded toward the negative side in the X axis direction and makes point contact with the rust-resistant member 27.

Due to the point contact, the diameter φD27 of the rust-resistant member 27 may be set to be smaller than the diameter φD221 of the plunger pin 221. In this way, the rust resistant member 27 may be reduced in size.

Although the electromagnetic valve of the disclosure has been described above with the exemplary embodiments of the drawings, the disclosure is not limited thereto. Each part which configures the electromagnetic valve may be replaced with any configuration which may exhibit the same function. Moreover, any component may be added.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electromagnetic valve, comprising:
a solenoid comprising:
a bobbin in a cylindrical shape having a through hole which penetrates along an axial direction;
a plunger inserted into the through hole and supported movably along the axial direction; and
a coil wound around an outer periphery of the bobbin and generating a magnetic force when energized to move the plunger; and
a valve mechanism comprising:
a flow path member connected to the solenoid and having a first flow path, a second flow path, a relay flow path connecting the first flow path and the second flow path, and a valve body housing disposed adjacent to the relay flow path along the axial direction; and
a valve body in a columnar shape inserted into the valve body housing, supported movably along the axial direction together with the plunger, and switching between passage and blockage of a fluid between the first flow path and the second flow path via the relay flow path,
wherein the solenoid has:
a core in a cylindrical shape provided on one side of the through hole in the axial direction, guiding the plunger when the plunger moves, and having magnetism; and
a yoke in a cylindrical shape provided on the other side of the through hole in the axial direction, guiding the plunger when the plunger moves, and having magnetism,
the plunger has a plunger pin protruding at least on the other side in the axial direction in the one side in the axial direction and the other side in the axial direction, and
a rust-resistant member having rust resistance is provided on an end of the yoke on the other side in the axial direction, wherein the plunger pin comes into contact with and separates from the rust-resistant member as the plunger moves, and the rust-resistant member has an area larger than a contact area of the plunger pin with the rust-resistant member.

2. The electromagnetic valve according to claim 1, wherein the rust-resistant member is made of stainless steel.

3. The electromagnetic valve according to claim 1, wherein the yoke has a recess in the end on the other side in the axial direction, and the rust-resistant member is housed in the recess.

4. The electromagnetic valve according to claim 2, wherein the yoke has a recess in the end on the other side in the axial direction, and the rust-resistant member is housed in the recess.

5. The electromagnetic valve according to claim 1, wherein the rust-resistant member has a plate shape.

6. The electromagnetic valve according to claim 3, wherein the rust-resistant member has a plate shape.

7. The electromagnetic valve according to claim 1, wherein the rust-resistant member has a diameter larger than a diameter of the plunger pin when viewed from the axial direction.

8. The electromagnetic valve according to claim 4, wherein the rust-resistant member has a diameter larger than a diameter of the plunger pin when viewed from the axial direction.

9. The electromagnetic valve according to claim 1, wherein an end surface of the plunger pin on the other side in the axial direction is rounded, and
the rust-resistant member has a diameter smaller than a diameter of the plunger pin when viewed from the axial direction.

10. The electromagnetic valve according to claim 4, wherein an end surface of the plunger pin on the other side in the axial direction is rounded, and
the rust-resistant member has a diameter smaller than a diameter of the plunger pin when viewed from the axial direction.

11. The electromagnetic valve according to claim 1, wherein the rust-resistant member restricts a movement limit of the plunger when the plunger pin contacts the rust-resistant member.

12. The electromagnetic valve according to claim 6, wherein the rust-resistant member restricts a movement limit of the plunger when the plunger pin contacts the rust-resistant member.
